(19) United States
(12) Patent Application Publication
(10) Pub. No.: US 2010/0012066 A1
(43) Pub. Date: Jan. 21, 2010

(54) Method of increasing the combustion efficiency of an internal combustion engine

(76) Inventor: Wei Hua Wang, Xizhi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,172

(22) Filed: Jul. 17, 2008

(51) Int. Cl. F02B 47/00; F02M 25/00

(52) U.S. Cl. 123/1 A; 123/538

(57) ABSTRACT

In a method of increasing the combustion efficiency of a gasoline/diesel internal combustion engine for vehicles, vessels, aircraft, generators, etc., the following steps are included: mixing gasoline/diesel oil with an additive consisting of a plurality of highly electrically/thermally conductive nano molecules; allowing the nano molecules to attach to every gasoline molecular group/diesel oil molecule; and jetting the gasoline molecular groups/diesel oil molecules into a combustion chamber of the engine; at this point, in the case of a gasoline engine, the nano molecules immediately sensing an instantaneous high voltage released from a high-tension coil to release energy synchronously and thereby ignite the gasoline molecular groups; or, in the case of a diesel engine, the nano molecules quickly and evenly conducting heat energy of highly compressed hot air in the diesel engine among the diesel oil molecules for them to reach a self-combustion temperature; enabling complete combustion of the gasoline/diesel oil molecules.

### FIELD OF THE INVENTION

The present invention relates to a method of increasing the combustion efficiency of an internal combustion engine, and more particularly to a method of enabling complete combustion of fuel in a vehicle engine to achieve the purposes of saving fuel, protecting environment against pollution, and increasing the combustion efficiency of the vehicle engine.

### BACKGROUND OF THE INVENTION

It is known diesel and gasoline vehicles currently consume the largest part of the mineralized oil energy in the world, and the emission of HC, CO, NOₓ, etc. from these vehicles due to incomplete combustion of fuel thereof forms one of the main factors of greenhouse effect and global warming. The extent of reduction of vehicle fuel efficiency varies with vehicle conditions, road conditions, incomplete combustion, aged mechanical parts, driver's driving habit, etc. Generally, the percentage of combustion efficiency reduction is from about 8% to about 48%.

Among others, carbon deposition in the engine due to incomplete combustion of fuel is one of the most common key factors that bring to the reduced combustion efficiency, and generally results in 11%-36% of combustion efficiency reduction. Energy loss and emission of incompletely burned waste gases become worse and worse when the above problems of incomplete combustion and reduced combustion efficiency repeatedly and cyclically occur, resulting in serious environmental pollution.

FIG. 1 shows the general principle of combustion in a gasoline engine. When gasoline is released from a fuel supply 11, molecular groups 12 of the gasoline are atomized. The atomized gasoline molecular groups 12 are jetted into a combustion chamber of the engine. While part of the atomized gasoline molecular groups 12 are ignited by sparks from a spark plug, the remaining gasoline molecular groups 12 are sequentially ignited as a chain reaction through diffusion of the first ignited molecular groups 12. However, when the number of the discharge sparks produced by the spark plug each time is gradually reduced, or when the spark plug performance gradually lowers, not all the gasoline molecular groups 12 in the combustion chamber of the engine can be ignited at one time. Due to delayed chain reaction in the combustion chamber of the engine, a temperature gradient in the combustion chamber tends to occur. When the combustion chamber of the engine has some areas lower than 500° C. in temperature, incomplete combustion of some gasoline molecular groups 12 would occur in those areas to result in carbon deposit 13.

FIG. 2 shows the general principle of combustion in a diesel engine. When diesel oil is released from a fuel supply 21, diesel oil molecules 22 are divided by shearing forces into a plurality of tiny diesel oil molecules. When the tiny diesel oil molecules 22 are jetted into a combustion chamber of the engine, in which highly compressed and high-temperature hot airis filled, the diesel oil molecules 22 sequentially diffuse as a chain reaction while conducting heat, so that all the diesel oil molecules 22 gradually reach their self-combustion temperature to burn. However, when the heat conduction is incomplete in the chain reaction in the combustion chamber of the engine, temperature gradient would occur in the combustion chamber. When the combustion chamber of the engine has some areas lower than 500° C. in temperature, incomplete combustion of some diesel oil molecules 22 would occur in those areas to result in carbon deposit 23.

It is therefore tried by the inventor to develop a method to ensure complete combustion in vehicle engines, so as to increase the combustion efficiency of the engine.

### SUMMARY OF THE INVENTION

A primary object of the present invention is to provide a method of increasing the combustion efficiency of an internal combustion engine, so that fuel can be fully burned in the engine to achieve the purposes of saving fuel and protecting the environment against pollution by exhaust emission.

To achieve the above and other objects, the method of increasing the combustion efficiency of an internal combustion engine according to the present invention, when being applied to a gasoline engine, includes the steps of: mixing gasoline for the internal combustion engine with an adequate amount of additive consisting of a plurality of highly electrically conductive nano molecules; allowing the nano molecules of the additive to attach to every molecular group of the gasoline; supplying the gasoline molecular groups with the nano molecules attached thereto into a combustion chamber of the engine; at this point, the nano molecules quickly and uniformly sensing and conducting electric energy released from a high-tension coil, bringing the nano molecules to have energy level change and thereby release energy to ignite the gasoline molecular groups, so that the gasoline molecular groups synchronously and uniformly burn without producing carbon deposit.

When the method of the present invention is applied to a diesel engine, the following steps are included: mixing diesel oil for vehicles with an adequate amount of additive consisting of a plurality of nano molecules, which have super-high heat conductivity; allowing the nano molecules to attach to every molecule of the diesel oil; and jetting the diesel oil molecules into the internal combustion engine, in which highly compressed hot air is filled, so that the nano molecules with super-high heat conductivity attached to the diesel oil molecules quickly and uniformly conduct heat energy synchronously, enabling the diesel oil molecules to reach a self-combustion temperature thereof and achieve an effect of complete combustion.

Therefore, the method of the present invention is useful for both gasoline and diesel internal combustion engines to achieve complete combustion without forming carbon deposit therein.

In the method of the present invention, the additive for mixing with the fuel for the internal combustion engine consists of a plurality of hollow carbon nano capsules.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual view showing the combustion of conventional gasoline in an internal combustion engine;

FIG. 2 is a conceptual view showing the combustion of conventional diesel oil in an internal combustion engine;

FIG. 3 is a conceptual view showing the combustion of gasoline in an internal combustion engine according to the method of the present invention; and

FIG. 4 is a conceptual view showing the combustion of diesel oil in an internal combustion engine according to the method of the present invention.

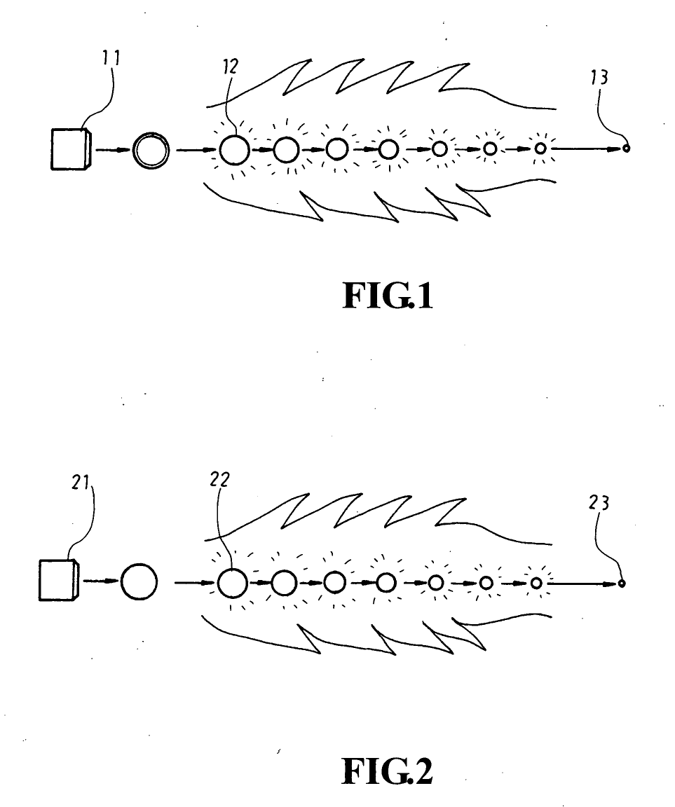

### DETAILED DESCRIPTION OF THE PREFERRED EMBODIMENTS

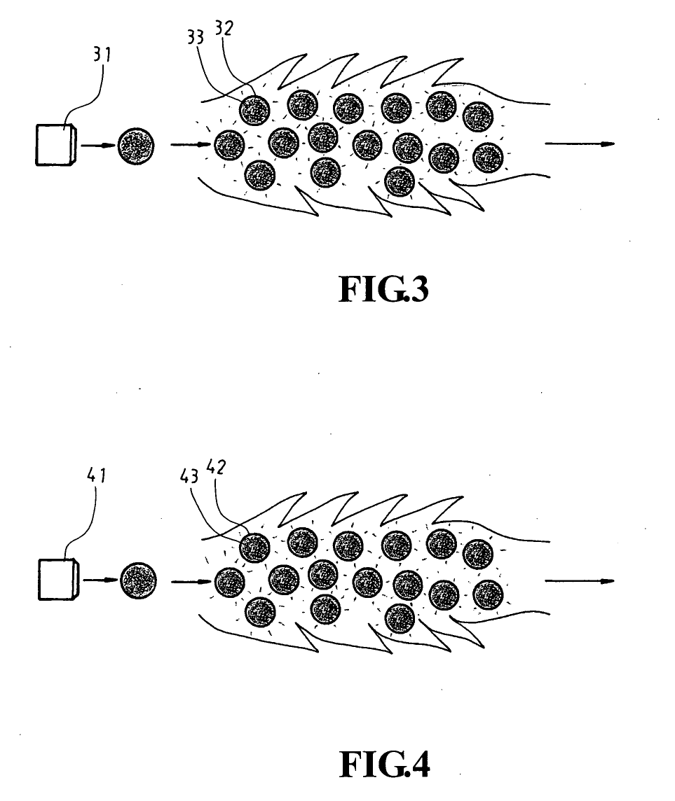

Please refer to FIG. 3. In a method of the present invention for increasing the combustion efficiency of an internal combustion engine, fuel for the internal combustion engine is mixed with an adequate amount of additive. The additive consists of a plurality of nano molecules. When the additive is dissolved in the internal combustion engine fuel, the nano molecules of the additive rapidly and evenly conduct electric energy or heat energy to achieve the effect of complete combustion of the fuel in a combustion chamber of the engine.

When the method of the present invention is applied to a gasoline engine, the following steps are included:
1. Releasing gasoline from a fuel supply 31. At this point, molecular groups 32 of the gasoline are atomized;
2. Allowing numerous nano molecules 33 of an additive to attach to the atomized gasoline molecular groups 32; and
3. The nano molecules 33, due to their excellent electrical sensing and conducting property, quickly and directly sensing an instantaneous high voltage of about 15000V released from a high-tension coil, bringing the highly electrically conductive nano molecules 33 to have energy level change and release energy to ignite all the gasoline molecular groups 32. That is, all the gasoline molecular groups 32 are simultaneously transferred and diffused to burn uniformly at the same time, and carbon deposition in the engine due to incomplete combustion is avoided.

Please refer to FIG. 4. When the method of the present invention is applied to a diesel engine, the following steps are included:
1. Releasing diesel oil from a fuel supply 41. At this point, the diesel oil is divided by shearing forces into a plurality of tiny diesel oil molecules 42. Then, allowing numerous nano molecules 43 of an additive to attach to the tiny diesel oil molecules 42;
2. Jetting the diesel oil molecules 42 at a high pressure of about 20000 PSI into the engine, in which highly compressed hot air of from about 500° C. to about 800° C. is filled. Since the nano molecules 43 are highly heat-sensitive and have super-high heat conductivity, heat energy can be quickly diffused via the nana molecules 43 to all the diesel oil molecules 42, enabling the diesel oil molecules 42 to synchronously, quickly, and uniformly reach a self-combustion temperature thereof; and
3. the diesel oil in the internal combustion engine being fully burned to achieve the effect of complete combustion without forming any carbon deposit.

In the method of the present invention, the additive for mixing with the fuel for the internal combustion engine consists of a plurality of hollow carbon nano capsules.

According to the above description, the method of the present invention provides at least the following advantages:
(1) In a perfect complete combustion reaction, fuel loss due to incomplete combustion can be reduced by 11-36% with an average of 25%.
(2) The internal combustion engine can have increased power output and extended service life to thereby reduce the maintenance cost thereof.
(3) Due to the perfect complete combustion reaction, the emission of various kinds of greenhouse gases, including HC, CO, NOₓ, etc., can be largely reduced with the exhaust emission reduction efficiency upgraded from 37% to 70%.
(4) Different economical benefits, such as lowered fuel consumption, extended usable years of mineralized oil resources, and development of other alternative energies, could be achieved. Moreover, with the method of increasing the combustion efficiency of an internal combustion engine according to the present invention, it is possible to effectively suppress the greenhouse effect that results in the disaster of global warming. Therefore, the method of the present invention is novel and practical for use.

What is claimed is:

1. A method of increasing the combustion efficiency of an internal combustion engine, comprising the steps of:
mixing gasoline for an internal combustion engine with an adequate amount of additive consisting of a plurality of highly electrically conductive nano molecules;
allowing the nano molecules to attach to every molecular group of the gasoline; and
supplying the gasoline from a fuel supply into a combustion chamber of the internal combustion engine; at this point, the highly electrically conductive nano molecules of the additive sensing and conducting a high voltage from a high-tension coil to have an energy level change and thereby release energy to ignite the gasoline molecular groups, to which the nano molecules are attached, enabling the gasoline molecular groups to synchronously and uniformly burn without producing carbon deposit.

2. The method of increasing the combustion efficiency of an internal combustion engine as claimed in claim 1, wherein the additive mixed with the gasoline for the internal combustion engine consists of a plurality of hollow carbon nano capsules.

3. A method of increasing the combustion efficiency of an internal combustion engine, comprising the steps of:
mixing diesel oil for vehicles with an adequate amount of additive consisting of a plurality of nano molecules having super-high heat conductivity;
allowing the nano molecules to attach to every molecule of the diesel oil;
releasing the diesel oil from a fuel supply; at this point the diesel oil being divided by shearing forces into a plurality of tiny diesel oil molecules; and
jetting the diesel oil molecules into an internal combustion engine, in which highly compressed and high-temperature hot air is filled; at this point, the nano molecules with super-high heat conductivity attached to the diesel oil molecules synchronously, quickly, and uniformly conducting heat energy for the diesel oil molecules to reach a self-combustion temperature thereof and achieve an effect of complete combustion.

4. The method of increasing the combustion efficiency of an internal combustion engine as claimed in claim 3, wherein the additive mixed with the diesel oil for the internal combustion engine consists of a plurality of hollow carbon nano capsules.
